(19) United States
(12) Patent Application Publication
(10) Pub. No.: US 2006/0181759 A1
(43) Pub. Date: Aug. 17, 2006

(54) Electrochromatic polymer mirror surface for vehicle blind spot exposure

(76) Inventor: Khaled Malhas, Ann Arbor, MI (US)

Correspondence Address: WHITE-WELKER & WELKER, LLC, P.O. BOX 199, CLEAR SPRING, MD, 21722-0199, US

(21) Appl. No.: 11/354,516

(22) Filed: Feb. 15, 2006

Related U.S. Application Data
(60) Provisional application No. 60/653,344, filed on Feb. 16, 2005.

(51) Int. Cl. G02F 1/15

(52) U.S. Cl. 359/265

(57) ABSTRACT

The present invention teaches the use of a blind spot exposure system comprised of two consecutive reflective mirror surfaces. The first mirror surface is formed of an electrochromatic polymer while the second reflective surface is composed of conventional reflective mirror glass. The two surfaces are positioned such as the first electrochromatic reflective surface forms the reflected view in the vehicle's side mirror during the system's normal operating state. Once the system is activated electrical voltage is applied to the electrochromatic first surface rendering it transparent thereby uncovering the conventional reflective mirror surface behind it which is offset by a fixed blind spot exposure angle that may range between +4 degrees and +24 degrees. The present invention also teaches of a number of alternative embodiments including: an anti-glare automatic dimming mode based on the use of an optional external light sensor, the integration with a vehicle's turn signals or external sensors as means of activating the blind spot exposure state, the ability to produce a speed sensitive mode in which the system engages in blind spot exposure mode for a shorter period of time at higher vehicular speeds; and the use of LED indicators to provide visual notification whenever the system in a given side mirror is in an expanded blind spot exposure state.

### CROSS REFERENCE TO RELATED APPLICATIONS

This application claims priority from U.S. Provisional Patent Application Ser. No. 60/653,344, entitled “Electrochromatic Polymer Mirror Surface for Vehicle Blind Spot Exposure”, filed on Jan. 16, 2005.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a controlled mirror system that temporarily alters the reflective angle of mirror surface to reflect an alternative viewing angle. More specifically the present invention teaches the use of an electrochromatic automotive side mirror surface that, upon driver's demand or based on sensor input, widens its angle of reflection of the side mirror(s) thereby exposing the contents of the vehicle's blind spot.

### BACKGROUND OF THE INVENTION

Motor vehicles rely on two mirrors mounted on each side of the vehicle to uncover objects, including other vehicles such as passing or trailing traffic, next to them and behind them. These side mirrors are based on a design that is incapable of displaying, or “detecting”, a vehicle occupying a directly adjacent lane and approaching the reference vehicle from the rear such as the situation of a faster vehicle passing a slower vehicle. As part of basic driving instruction, drivers are often taught to check their blind spot zone before executing a lane change by turning the driver's head by as much as 90 degrees in the direction of the desired lane check/change.

The blind spot phenomenon is pervasive among virtually all passenger cars, light and medium trucks and vans, and all sport utility vehicles. Some medium and heavy-duty vehicles, resort to mounting multiple side view mirrors to alleviate this problem.

Many blind spot exposure and detection mechanisms used by motorists and described in the prior art embody entirely manual tasks. Such manual techniques to the persistent blind spot problem are inherently flawed and posses several shortcomings.

One shortcoming of prior art systems is that the driver is required to direct his/her direction away from the road ahead. This head turning task is strictly voluntary to the driver. Driver fatigue or low alertness levels often contribute to ignoring or neglecting to perform this manual check when changing lanes.

Another shortcoming inherent with manual techniques is the human perception of the sight ahead is based on a concept of continuity. A driver's “Frame Of Reference” (also referred to as “FOR”) is a series of continuous images transmitted to the driver's brain from a moving scene ahead. Sudden shifts in a specific scene caused by a swift movement of the head will require additional brain processing time, known as Frame of Reference Adaptation Time. FOR Adaptation Time in a conventional blind spot check is measured as the time between the driver's head returning back to its original road-facing position after executing a manual blind spot check and the time required by the brain to refocus the scene of the road and traffic ahead including any changes in traffic patterns ahead such as vehicle movements, new vehicles, road or traffic signals, and road shape. Thus, any invention that eliminates or reduces FOR Adaptation Time can provide significant benefits in collision avoidance.

Another well-known problem in the prior art is that vehicle designs vary widely. Some vehicles have severely restricted side view through and behind the driver side B-pillar. This occurs most commonly in some sports cars and convertibles. Similarly, tall SUVs, while having ample viewing room up to the B-pillar on the driver side, have impeded blind spot view due to their relatively large dimensions, including height. In essence, any B-pillar or height design issues inherently limit the side and rearward view through the driver's side window. This consequently further limits the reliability and efficiency of conventional blind spot checking mechanisms known in the prior art in preventing avoidable lane change collisions.

Various devices have been devised to cause the side rearview mirrors of a vehicle to either expose a vehicle's blind spot area or to detect objects occupying the vehicle's blind spot zone. Virtually all emerging blind spot detection systems known in the prior art rely on an electronic sensing or detection mechanism to alert the driver when an object has entered his/her blind spot zone.

For the foregoing reasons, conventional blind spot detection systems known in the prior do not have sufficient means for providing significant benefits in collision avoidance.

What is needed is a blind spot exposure system that is automated in response to a single driver engagement, provides for blind spot exposure, then returns to its normal operating state that is readily adaptable for implementation in any vehicle, regardless of vehicle design or size.

### SUMMARY OF THE INVENTION

The present invention is a system that augments conventional power side mirror designs and is capable of reflecting a wider side view of the vehicle to the driver based on either driver activation or passive activation when coupled with an external sensory system. Virtually all emerging blind spot detection systems known in the prior art rely on an electronic sensing or detection mechanism to alert the driver when an object has entered his/her blind spot zone. Conversely, the present invention is a blind spot exposure system that exposes the blind spot zone to the driver using a familiar, ergonomically-accepted interface: the vehicle's side mirror. With the present invention, the driver is empowered to make informed driving decisions based on his/her own assessment of the exposed contents of the blind spot zone.

The present invention teaches the use of an electrochromatic automotive side mirror surface that, upon driver's activation or based on sensor output signal, produces a wider angle of reflection of the side mirror, thereby exposing the contents of the vehicle's blind spot. The present invention is based on a micro-controlled digital circuit that applies an appropriately high voltage level to the electrochromatic polymer through the power mirror's wiring connection.

Upon application of voltage, the electrochromatic mirror surface becomes transparent thereby exposing a second, conventional mirror surface positioned and offset behind it. As the conventional mirror surface is offset by a specific angle, for example +4 to +24 degrees, depending on the vehicle geometry and a number of additional factors, the angle of reflection of the driver's view is increased by the offset angle of the conventional mirror's surface to that of the electrochromatic mirror surface. This increase in the angle of reflection exposes a wider angle of the space next to and behind the vehicle, thereby exposing the vehicle's blind spot zone to the driver.

The duration of application of rendering transparent the electrochromatic mirror (also referred to as the “duration of blind spot zone exposure”) can be defined in one the following ways:

A fixed time interval;

A fixed time interval that is driver-configurable;

A fixed time interval that can be extended based on some driver input in order to prolong the duration of blind spot zone exposure (such as in a lane merge situation). This can be accomplished by providing a blind spot zone exposure timing override function that may be invoked by the driver keeping the activation button depressed for a longer period than the pre-defined time interval;

When coupled with an external sensing mechanism, a variable time interval that is determined through the continuous output signal from the sensor, which monitors the contents of the blind spot zone. i.e. the system continues to expose the blind spot zone as long as the sensing system detects the presence of a moving object within it;

A variable time interval based on the vehicle's speed. Through continuous acquisition of the vehicle's speed, the circuit can determine the appropriate duration of blind spot exposure to ensure greater responsiveness to the driver's real-time needs. i.e. the faster the vehicle, the shorter the blind spot exposure interval shall be.

The present invention's mode of operation is described by the following three operating states:

The first operating state is referred to as the Normal Reflected View state. In this state the driver views the normal fully reflective surface of the electrochromatic mirror. The reflective property of the electrochromatic polymer is present due to lack of application of electrical voltage by the system's microcontroller;

The second operating state is referred to as the Blind Spot Exposure state. In this state the driver views the wider reflection angle provided by the conventional mirror surface positioned behind the electrochromatic mirror surface. In this state the secondary conventional mirror surface becomes visible as the electrochromatic mirror surface is rendered transparent due to the application of electrical voltage on the electrochromatic polymers by the system's microcontroller;

The third operating state is referred to as the Auto-Dimming state. This state is a derivative of the above Normal Reflected View state and is not necessary for the successful implementation of the present invention. This state is a transitional state of the electrochromatic mirror's reflective property that enables continuous auto-dimming property to the electrochromatic polymer.

The auto-dimming property is actuated through continuous input from the optional photocell attached to the electrochromatic mirror surface and facing the rear of the vehicle either at the same angle of reflection as the electrochromatic mirror surface or at a slightly greater angle (outwardly facing away from the vehicle). The photocell sends a signal that describes the luminescence of the incident light beams on the electrochromatic mirror surface. The circuit logic (in the digital microcontroller) in turn interprets the photocell's signal and calculates a level of partial voltage application to the electrochromatic mirror surface. The partial voltage renders the electrochromatic mirror surface variably translucent wherein a certain percentage of light rays are absorbed through the electrochromatic mirror surface rather than reflected. This process accomplishes an anti-glare, auto-dimming function for side mirrors.

It is therefore an object of the present invention to produce a blind spot exposure state that is automated in response to a single driver engagement or the output of an external sensor, provides for blind spot exposure, then returns to its normal operating state that is readily adaptable for implementation in any motor vehicle.

In accordance with the present invention, an electronically controlled mirror system for vehicle blind spot exposure is provided and described in detail hereafter.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is an aerial view of viewable and blind spot zones next to and behind a reference vehicle in traffic;

FIG. 2 illustrates the significant expansion in blind spot coverage area that occurs as the system of the present invention is activated;

FIG. 3 illustrates the placement of the present invention and the controls for engaging the system of the present invention;

FIG. 4 is a detailed view of the present invention's system components placed within a conventional enclosure of a vehicle's power side mirror system;

FIG. 5 is a side-facing view of the chassis and physical angular offset between the electrochromatic mirror surface and the conventional mirror surface;

FIG. 6 is an aerial view of the chassis and physical angular offset between the electrochromatic mirror surface and the conventional mirror surface;

FIG. 7 shows the angle of light rays' incidence and reflection during the normal running mode of the present invention;

FIG. 8 shows the angle of light rays' incidence and reflection during the blind spot exposure mode of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the pertinent arts to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail so as not to obscure the invention.

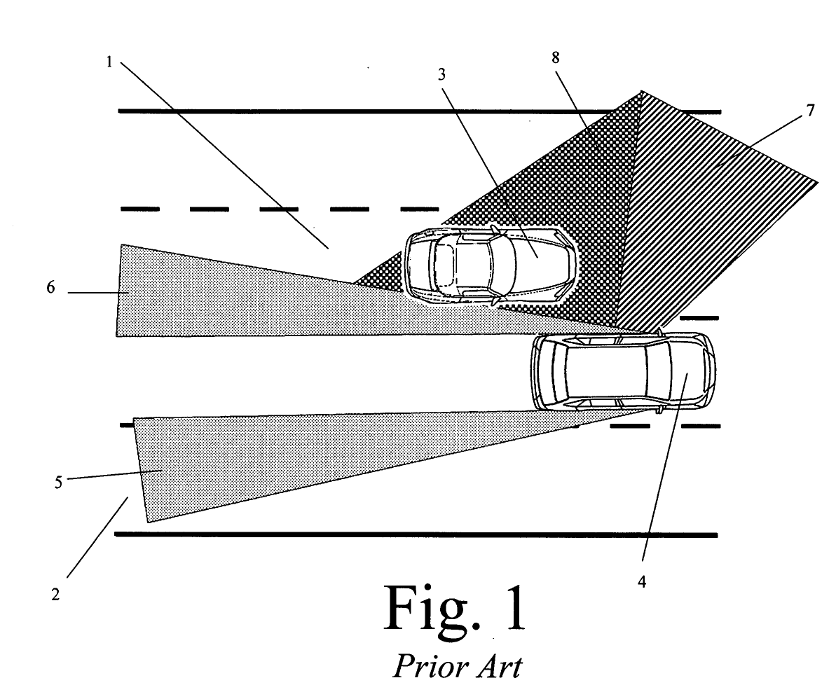

Now referring to FIG. 1, an aerial view of viewable areas next to 7 and viewable areas behind 5 & 6 a first vehicle 4, and blind spot areas 8 of a first vehicle 4 travelling in a first traffic lane 2 are illustrated. The overall phenomenon of a second vehicle 3 in an adjacent second lane 1 becoming invisible in a driver's side mirror 10 is known as the “blind spot” or “blind spot zone.” The location of a traditional blind spot 8 is based on the following factors: the distance of the position of the side mirror 10 to the driver's eyes, the width of the mirror surface 20, the width of the object behind the reference vehicle 9 in an adjacent lane, the driver-specified position of the side mirror 10, and the inflection of the mirror's reflective surface, either a concave or convex mirror.

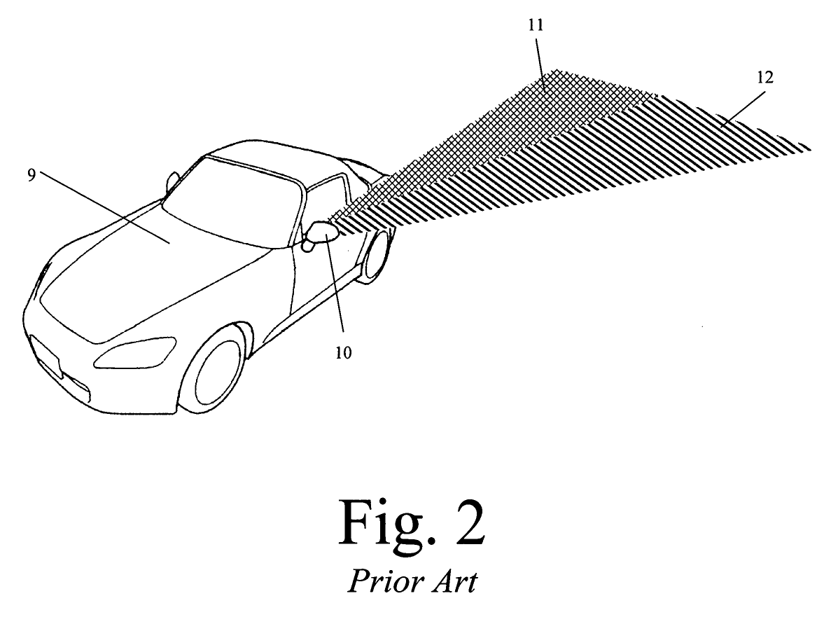

FIG. 2. illustrates the vehicle's 9 side mirror's 10 reflected viewable area during normal running mode (also referred to as Operating State A) 11 and the expanded reflected viewable area 12 due to the activation of the present invention resulting in the exposure of the blind spot zone 12 (also referred to as Operating State B).

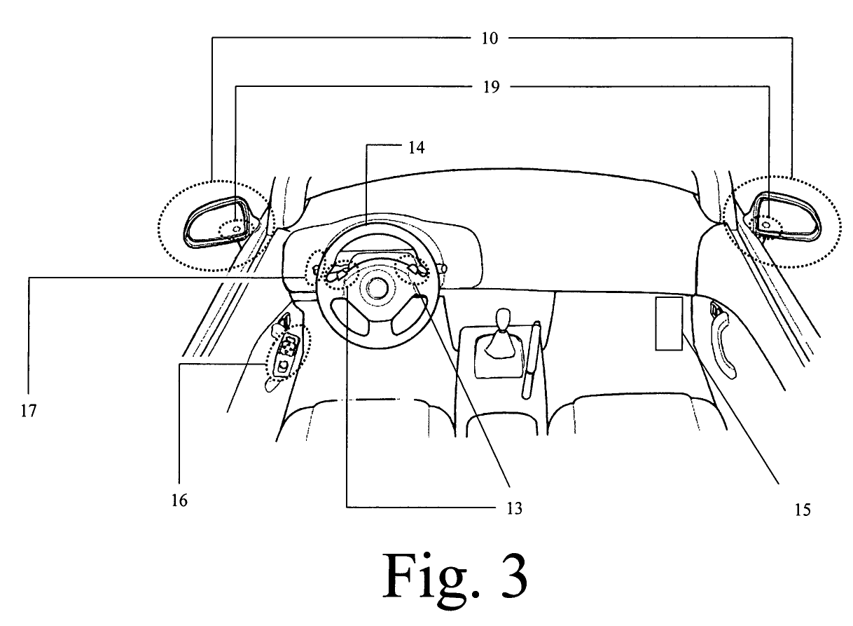

FIG. 3. illustrates the overall layout of the system's components that are located inside a conventional power mirror enclosure 10 on either side of the vehicle 9.

The present invention's activation buttons 13 are located on the vehicle's 9 steering wheel. Each button 13 allows the driver to momentarily change the system's operating state in the corresponding power mirror 10 from its normal running mode to its blind spot exposure mode and then returning to the normal operating mode.

The vehicle's 9 steering wheel is a suggested ergonomic position to place the system's activation buttons 13. The shape, size and proper placement of the system's activation buttons inside the cabin of the vehicle 9 and within the view and reach of the driver are not in scope of the design of the present invention and are left to persons experienced in the art of motor vehicle interior design.

FIG. 3, element 15 (not shown). refers to the system's microcontroller circuitry which regulates the application, actuation, duration, and switching between system's operating modes (Operating States A, B and C). The microcontroller circuit of the present invention is linked to the vehicle's accessory power source (+12 volts), vehicle ground, each power mirror's wiring harness 23, system activation buttons 13, vehicle's left and right turn signals 17, any external sensors used as inputs for switching the system's operating states, including, but not limited to, the vehicle's speedometer, continuous digital imaging devices, ultrasonic, thermal, infrared or laser blind spot object detectors and any photo or light sensors 19.

The system's microcontroller circuit 15 includes all electronic hardware required to regulate, control, and power the transparent, reflective and glare filter, auto-dimming states of the electrochromatic mirror surface 18. The physical design of the microcontroller circuit 15 is not in scope of the present system's design and is left to persons of ordinary skill in the art.

The vehicle's 9 conventional power mirror 10 adjustment controls serve to physically adjust the lateral or vertical position of the overall chassis 24 and the electrochromatic mirror surface 18 and second reflective mirror surface 20 that comprise the present invention's dual-pane mirror structure. The vehicle's traditional power mirror adjustment hardware provides the foundation for adjusting the orientation of the present invention's structure.

Electronic photocells 19 can be applied as part of the present invention's system to continuously produce a digital electronic signal describing the luminescence level or glare of the light rays incident upon the power mirror's first surface 18.

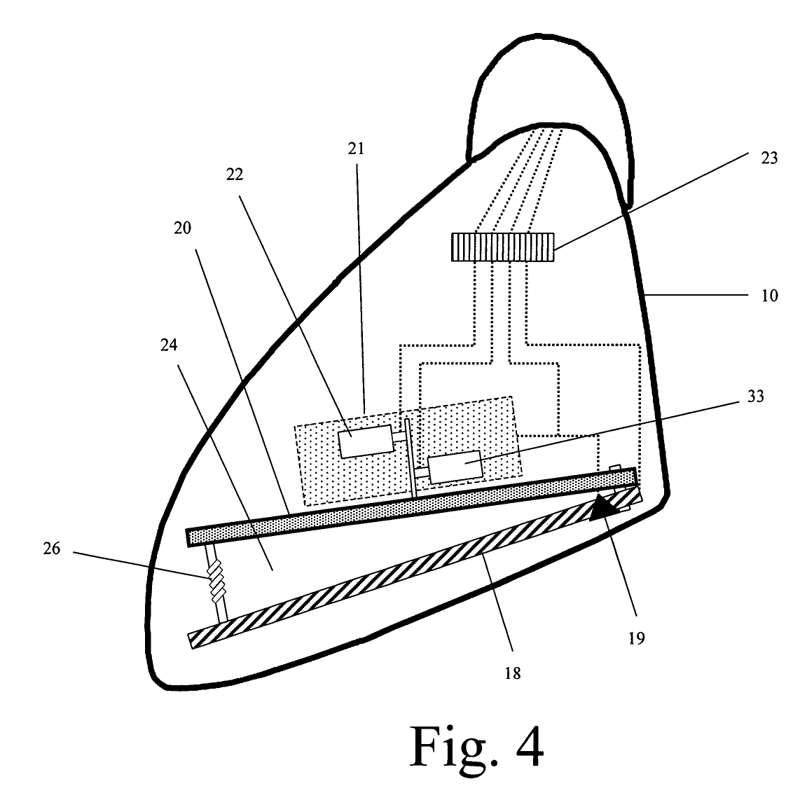

FIG. 4 illustrates the structure and layout of the main mirror-side components of the present invention. In the vehicle's side mirror enclosure 10, a flat chassis 24 is located in a parallel plane to the ground. To the chassis 24 a first reflective mirror surface 18 is affixed in a plane perpendicular with respect to the chassis 24 and faces the rear of the reference vehicle.

The first reflective surface 18 is based on a variable reflection electrochromatic polymer that is actuated by the variable application of electrical voltage. The first reflective mirror surface 18 may contain an embedded photocell 19 that can provide continuous luminescence data to the present invention's microcontroller 15. The application of the photocell 19 is required if the auto-dimming operating state of the electrochromatic surface is implemented.

Directly behind the first reflective mirror surface 18 lays a second reflective mirror surface 20 which is offset from the first reflective mirror surface 18 by a pre-determined blind spot exposure angle 27. The blind spot exposure angle 27 can be between +4 degrees and +24 degrees depending on the geometry of the reference vehicle. The second reflective mirror surface 20 is comprised of conventional glass mirror material and is placed directly behind the first reflecting mirror surface 18 at its end closest to the vehicle and by a specific offset distance at the outermost end of its reflective surface. The distance between the outermost ends of the first 18 and second mirror 20 surfaces culminates into the desired blind spot exposure angle 27.

Further, a connector 26 is used to connect the first 18 and second mirror 20 surfaces at their respective outermost ends. The connector 26 maybe a solid fixed connector that maintains the offset angle 27 between the first 18 and second reflective mirror 20 surfaces or it may be comprised of an adjustable worm gear that allows for the manual readjustment of the built-in blind spot exposure offset angle 27.

Now referring to the power mirror's conventional adjustment motor assembly 21. This motor assembly 21 is comprised of a first electric motor 22 that shifts the entire dual-pane assembly of the present systems vertically based on the driver's input into the power mirror adjustment controls 16. A second electric motor 33 similarly modifies the lateral position of the present invention's dual-pane assembly, collectively shown as 18, 19, 20, 24, and 26, based on the driver's input into the power mirror adjustment controls 16. The application of the conventional power mirror motors' assembly 21 is intended to apply the driver's adjustments of the overall system without modifying the fixed offset angle of blind spot exposure 27 prescribed in the present invention.

Lastly, the power mirror's wiring harness 5 and connector 23 are shown. The wiring harness 23 is comprised of all wiring required for the conventional functions of the power side mirror in addition to the electrical control lines required for the application of electrical voltage to the electrochromatic reflective mirror surface. In addition, any wiring required for external system sensors, such as the embedded photocell, is shown in 23.

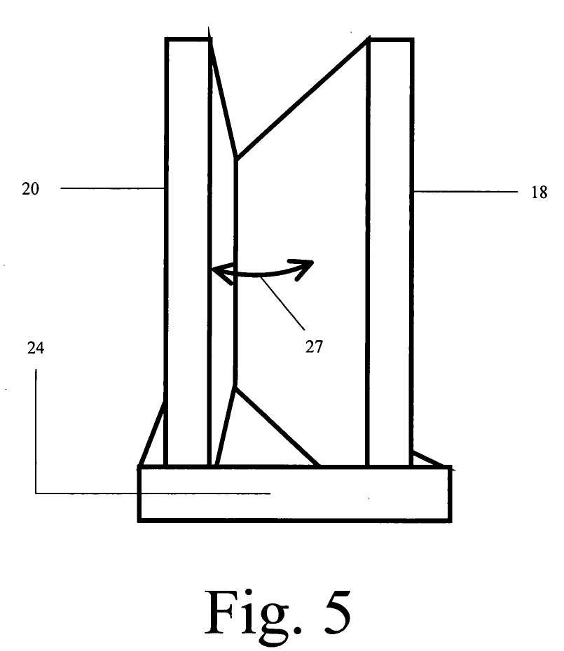

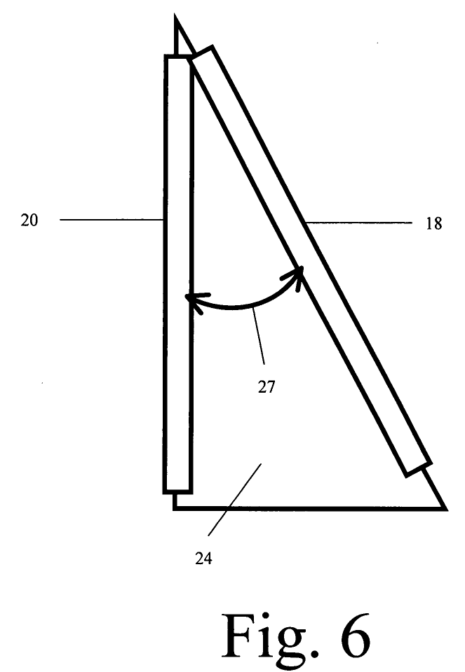

The present system's prescribed offset angle for blind spot exposure 27 is shown through a side view of the dual pane surface assembly in FIG. 5 and through an aerial view in FIG. 6. The spatial relationship between the first reflective mirror surface 18, the chassis tray 24 and the second reflective mirror surface 20 is also shown.

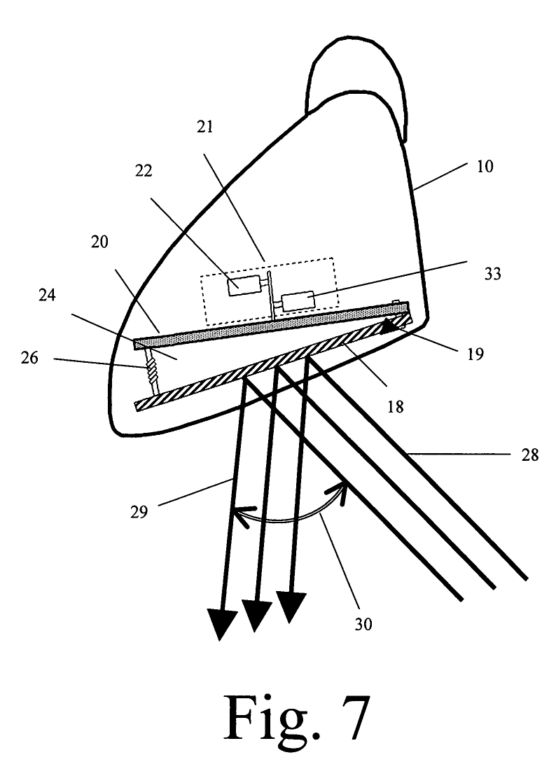

FIG. 7 illustrates the position of the incident 28 and reflected 29 light rays upon the first reflective mirror surface 18 when the system is in its normal running mode (Operating State A; and Operating State C of continuously variable transparency for the purpose of auto-dimming and glare absorption). The angle of reflection during normal operating mode 30 is shown.

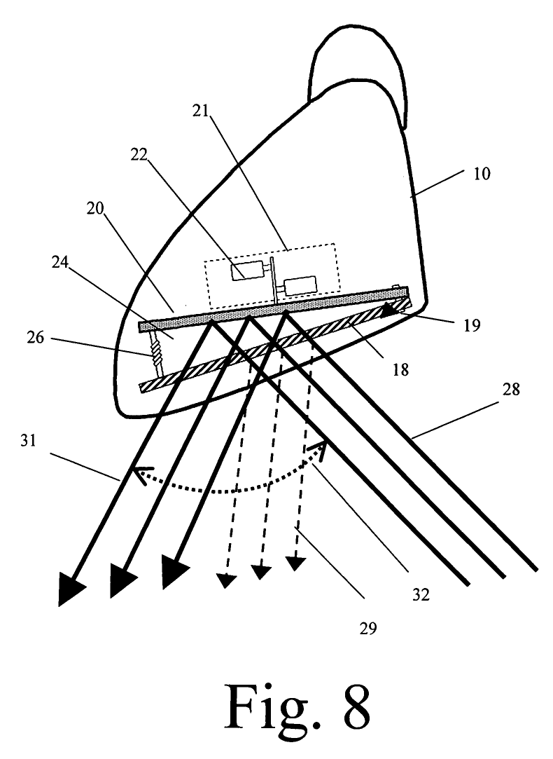

FIG. 8 illustrates the expanded position of the incident 28 and reflected 31 light rays upon the exposed second reflective mirror surface 20 when the system is operating in blind spot exposure mode (Operating State B). The angle of widened reflection 32 for blind spot exposure is shown. The extent of expansion in reflection in this system state is expressed as:
f(x)=x+a
whereby f(x) denotes the expanded angle of reflection when the present invention is engaged in blind spot exposure mode 32; x is the normal operating reflection angle of the present invention 30; and a is blind spot exposure angle built into the present invention within the range of +4 degrees to +24 degrees depending on the reference vehicle's geometry. α is the same angle of physical offset 27 between the first 18 and second 20 reflective mirror surfaces taught by the present invention.

Now the system's three states of operation are explained in detail. The present invention specifies three possible discrete states for system operation. They are follows:

Normal Operating Run Mode, Operating State A

Operating State A is the default operating state in which the system is set when it is powered up. This state denotes the normal operating mode of the present invention in which the electrochromatic first surface 18 is engaged in fully reflective mode by the system's microcontroller 15. In this state the normal operating reflected view 28, 29 in the first mirror surface 18 is the conventional rearward reflected view of said mirror surface as configured by the driver using the vehicle's native power mirror adjustment controls 16. Further, the system's microcontroller 15, in this state, continuously monitors all interface lines 23 for any external activation of the blind spot exposure mode (Operating State B). The possible methods for activating the present invention shall be explained in detail further below.

Blind Spot Exposure Mode, Operating State B

In Operating State B the system's microcontroller 15 renders the first electrochromatic surface 18 transparent thereby exposing the offset second conventional reflective mirror surface 20 and producing a widened angle of reflection 32 for the purpose of blind spot exposure. The duration for which the system is engaged in such blind spot exposure state shall be explained in detail further below.

Auto-Dimming Normal Run Mode, Operating State C

Operating State C is an enhanced auto-dimming operating mode that effectively replaces Operating State A as the default normal run mode of this system. Operating State C inherits all of the methods and properties of Operating State A. Operating State C must be coupled with the use of a light or glare sensor 19 that continuously collects and reports to the system's microcontroller 15 the digital measurement of luminescence of incident light rays 28 upon the first reflective mirror surface 18. The microcontroller 15 through its on-board program in turn calculates and continuously adjusts the electrical voltage applied to the first electrochromatic mirror surface 18 so as to actuate the amount of light said surface reflects compared to the amount of light that is allowed to pass through the electrochromatic surface.

The variability in reflecting a dynamically calculated subset of incident light rays therefore generates the benefit of real-time auto-dimming or glare absorption of light rays incident on the present invention 28.

The activation means of invoking the present invention's blind spot exposure mode are now described in detail. The present invention contemplates the transformation of the system from its normal operating run mode (Operating State A), or from its enhanced auto-dimming normal run mode (Operating State C), to the system's blind spot exposure mode (Operating State B) and back by any of the following manual or automatic methods. The following activation methods may be used solely or in combination (as applicable) to achieve the desired system behavior.

In a first activation method, the use of two manual activation buttons 13 mounted inside the cabin of the reference vehicle 9 within view and reach of the driver are used to activate the system. Each said button is intended for activating the present invention's blind spot exposure mode in the corresponding side mirror 10 direction. Manual activation buttons 13 may be:
i. a momentary switch such that a single button 13 engagement activates the system in blind spot exposure mode once. Upon engagement in blind spot exposure mode, the system returns to its normal operating mode after a delay period specified or calculated in the system's microcontroller;
ii. a push button or toggle switch 13 which, once activated, engages and holds the system in blind spot exposure mode until the push button switch is depressed a second time;

In a second activation mode, integration with the vehicle's conventional turn signals 17 triggers the activation of the system. Once the driver activates a turn signal 17, the system's microcontroller 15 engages the system in blind spot exposure mode in the direction of the side mirror corresponding to the turn signal 17. Upon engagement in blind spot exposure mode, the system returns to its normal operating mode after a delay period specified or calculated in the system's microcontroller 15, or the system's microcontroller 15 holds the affected side mirror in the blind spot exposure mode until said microcontroller 15 detects that the active turn signal 17 has been turned off;

In a third activation mode, integration with an external sensor which detects the presence of an object in one of the vehicle's blind spot zones controls activation of the system. Once such sensor output is communicated to the system's microcontroller 15 as an external activation triggering event, the system's microcontroller 15 consequently engages the side mirror 10 on the side of the detected blind spot impeding object into blind spot exposure mode. The microcontroller 15 may be programmed to execute a single system cycle of blind spot exposure, returning the affected side mirror 10 to its normal operating run mode once the delay period specified or calculated in the system's microcontroller 15 has elapsed; Or the microcontroller 15 may be programmed to keep the affected side mirror 10 held in blind spot exposure mode for as long as the external sensor indicates the continued presence of impeding object(s) in the respective blind spot zone.

The methods of calculating the duration of application of blind spot exposure mode upon a given side mirror 10 after the microcontroller 15 has received an activation signal are now listed and described. The time duration applied to an activated blind spot exposure state in a given mirror 10 is determined by:
1. An indefinite engagement of the blind spot exposure mode if the system's implementation is coupled with a toggle switch for system activation 13;
2. A fixed time interval preset in the system's microcontroller 15;
3. A variable time interval that is dynamically-calculated by the system's microcontroller 15 in response to the reference vehicle's 9 continuous real-time digital speedometer reading such that the duration of application of blind spot exposure is more brief at higher vehicle 9 speeds and visa versa. This speed sensitivity mode is especially significant as it increases the present invention's responsiveness to the driver's needs in real-time;
4. Continued engagement of external systems or sensors (such as the optional linkage to the vehicle's turn signals 17 or the use of blind spot detectors).

In addition to the above means of system-calculated or event-driven methods for determining the length of time period in which the system is engaged in blind spot exposure mode, the system's microcontroller 15 accepts overrides of the system-set time interval if the user keeps the respective activation button 13 depressed for as long as needed. This override produces more flexibility to the driver's needs when using the present invention. At the conclusion of the time duration set in, or calculated by the system's microcontroller 15, or after the release of a driver's override of such duration, the microcontroller 15 reverts back to the system's normal operating mode and returns to continuously monitoring for the next activation trigger event.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A system for automatically producing an expanded reflection angle in a vehicle power side mirror for the purpose of blind spot exposure comprising:
a first mirror element consisting of an electrochromatic surface capable of changing its properties of reflection and transparency given the variable application of electrical voltage to said electrochromatic polymer;
a second mirror element comprised of conventional reflective mirror glass;
a common chassis located within a vehicle's power side mirror enclosure wherein both said first mirror element and said second mirror element are mounted;
wherein the surface of said second mirror element is positioned behind and at an offset angle with the respect to the surface of said first reflective mirror element;
the common chassis is connected to the vehicle's power side mirror's conventional position adjustment assembly; and
the electrochromatic reflective surface of said first mirror element is connected, via the side mirror's wiring harness, to a system microcontroller which electronically controls the application of electrical voltage to the first electrochromatic reflective surface in accordance to pre-programmed logic.

2. The system for automatically producing an expanded reflection angle in a vehicle power side mirror for the purpose of blind spot exposure of claim 1 wherein the microcontroller is pre-programmed to produce two primary operating states of the first electrochromatic reflective mirror surface:
a first normal operating state in which the microcontroller applies the appropriate electrical voltage to the first electrochromatic surface rendering it entirely reflective; and
a second operating state for active blind spot exposure in which the microcontroller applies the appropriate electrical voltage so as to render the electrochromatic surface transparent thereby exposing the reflective mirror surface of the second mirror element behind and offset to the first mirror element.

3. The system for automatically producing an expanded reflection angle in a vehicle power side mirror for the purpose of blind spot exposure of claim 2 wherein:
the microcontroller is digital;
said digital microcontroller is coupled with an external light sensor or photocell;
said digital microcontroller is pre-programmed to produce a third, operating state of the electrochromatic reflective surface of said first mirror element in which the microcontroller applies continuously variable electrical voltage to the electrochromatic reflective surface of said first mirror element;
said digital microcontroller dynamically calculates and applies such continuously-variable electrical voltage onto the electrochromatic reflective surface of the first mirror element in response to a continuous supply of the external light sensor's real-time readings of the luminescence of light rays incident upon the electrochromatic reflective surface of said first mirror element; and
ensuing continuously-variable application of electrical voltage onto the electrochromatic reflective surface of said first mirror element for producing a variable, partial filtering of incident light rays onto said electrochromatic reflective surface of said first mirror element for the purpose automatically dimming the reflected glare incident upon first mirror surface.

4. The system for automatically producing an expanded reflection angle in a vehicle power side mirror for the purpose of blind spot exposure of claim 2 wherein the microcontroller accepts:
input from manual means of activating the system's blind spot exposure mode in which engagement of blind spot exposure mode is initiated by depressing an actuator placed inside the reference vehicle's cabin; and
manual means of activating the system's blind spot exposure mode in response to the activation of one of the reference vehicle's conventional turn signals.

5. The system for automatically producing an expanded reflection angle in a vehicle power side mirror for the purpose of blind spot exposure of claim 4 wherein the microcontroller may be pre-programmed to produce and sustain an expanded reflection angle based on continued presence of an activation signal during the entire period in which a turn signal is engaged.

6. The system for automatically producing an expanded reflection angle in a vehicle power side mirror for the purpose of blind spot exposure of claim 5 wherein the microcontroller is pre-programmed to restore said system to its normal operating state once the presence of an activation signal is no longer detected, or if a pre-programmed system delay period has elapsed, whichever occurs last.

7. The system for automatically producing an expanded reflection angle in a vehicle power side mirror for the purpose of blind spot exposure of claim 5 wherein the microcontroller incorporates a default time duration wherein said microcontroller holds the affected mirror in its blind spot exposure state after a manual or automatic activation of the system has occurred.

8. The system for automatically producing an expanded reflection angle in a vehicle power side mirror for the purpose of blind spot exposure of claim 1 wherein two indicator LED lights are mounted in a readily-viewable position in the reference vehicle such that
a left LED is activated by the microcontroller at any time during which the electrochromatic surface of the first mirror element of the left side mirror is engaged in full transparency state; and
a right LED is activated by the microcontroller at any time during which the electrochromatic surface of the first mirror element of the right side mirror is engaged in full transparency state.

9. The system for automatically producing an expanded reflection angle in a vehicle power side mirror for the purpose of blind spot exposure of claim 1 wherein
the two reflective mirror surfaces are offset by a fixed angle;
the offset angle equals the desired expansion in the reflective angle viewable through the first and second mirror surfaces; and
the range of said fixed offset angle is prescribed from +4 degrees to +24 degrees depending on the reference vehicle's geometry.

10. The system for automatically producing an expanded reflection angle in a vehicle power side mirror for the purpose of blind spot exposure of claim 9 wherein the offset angle separating the first and second reflective mirror surfaces is physically preset in the present system within the vehicle's side mirror assembly and enclosure using a solid physical connector.

11. The system for automatically producing an expanded reflection angle in a vehicle power side mirror for the purpose of blind spot exposure of claim 1 wherein:
the vehicle's conventional adjustment motors and power side mirror assemblies are positioned so as to directly enable modification of the baseline reflected angle viewable during the normal operating state of the overall system;
when either power mirror adjustment motor is activated manually by the in-cabin power mirror adjustment controls, the entire system's assembly is thusly moved along the corresponding adjustment motor's axis of rotation until the desired normal reflected view is reached; and
in any adjustment movement, the entire assembly is moved while fully preserving the preset blind spot exposure offset angle.

12. The system for automatically producing an expanded reflection angle in a vehicle power side mirror for the purpose of blind spot exposure of claim 2 wherein the microcontroller is designed to interface with blind spot object detection sensors that are based on differential digital imaging, thermal object detection, ultrasonic sensors, infrared and laser detection technologies.

13. The system for automatically producing an expanded reflection angle in a vehicle power side mirror for the purpose of blind spot exposure of claim 7 wherein the default time duration may be an adjustable value pre-programmed in the system's microcontroller.

14. The system for automatically producing an expanded reflection angle in a vehicle power side mirror for the purpose of blind spot exposure of claim 7 wherein
the time duration is dynamically-calculated by the system's microcontroller in response to the reference vehicle's speed expressed by the continuous real-time digital reading of the reference vehicle's speedometer; and
said microcontroller is pre-programmed to produce shorter durations of engagement of the blind spot exposure state at higher vehicular speeds and to produce longer durations of engagement of the blind spot exposure state at slower vehicular speeds.

15. The system for automatically producing an expanded reflection angle in a vehicle power side mirror for the purpose of blind spot exposure of claim 2 wherein the microcontroller accepts input from automatic means of activating the system's blind spot exposure mode in which engagement of blind spot exposure mode is initiated by the microcontroller receiving an electronic triggering event signal generated by an optional external blind spot object detection sensor.

16. The system for automatically producing an expanded reflection angle in a vehicle power side mirror for the purpose of blind spot exposure of claim 9 wherein the offset angle separating the first and second reflective mirror surfaces is manually adjustable using a variable length connector achieved by the implementation of a simple worm gear operating a variable length shaft.

17. The system for automatically producing an expanded reflection angle in a vehicle power side mirror for the purpose of blind spot exposure of claim 4 wherein the microcontroller may be pre-programmed to produce and sustain an expanded reflection angle based on continued presence of an activation signal if the system's activation button remains depressed.

18. The system for automatically producing an expanded reflection angle in a vehicle power side mirror for the purpose of blind spot exposure of claim 4 wherein the microcontroller may be pre-programmed to produce and sustain an expanded reflection angle based on continued presence of an activation signal while an external blind spot object detection sensor is producing a continuous triggering event.
